(19) United States
(12) Patent Application Publication
(10) Pub. No.: US 2008/0126679 A1
(43) Pub. Date: May 29, 2008

(54) Electronic Device with a Nonvolatile, Writable Data-Memory

(76) Inventor: Michael Philipps, Lorrach (DE)

Correspondence Address: BACON & THOMAS, PLLC, 625 SLATERS LANE, FOURTH FLOOR, ALEXANDRIA, VA, 22314, US

(21) Appl. No.: 11/632,209

(22) PCT Filed: Jun. 14, 2005
(86) PCT No.: PCT/EP05/52726

§ 371 Date: Dec. 19, 2007

(30) Foreign Application Priority Data
Jul. 13, 2004 (DE) 10 2004 034 042.0

(51) Int. Cl. G06F 12/00; G06F 12/02

(52) U.S. Cl. 711/103; 711/154; 711/E12.008; 711/E12.001

(57) ABSTRACT

An electronic device includes: A microprocessor; a nonvolatile, writable data-memory, which is writable for a predetermined maximum write-access number MWN of write-accesses; characterized in that the device includes a counter which registers the write-accesses and the microprocessor generates an alarm signal as a function of the development of the number of write-accesses and, as required, the maximum write-access number MWN.

The invention relates to an electronic device having a nonvolatile, writable data-memory e.g. an EEPROM, and, especially, to a field-device including a field-device electronics and a writable data-memory. The state of the art and the invention will be explained in the following, by way of example, with reference to field-devices. However, the invention is not limited to field-devices.

In process automation technology, preferably, field-devices are used for producing analog or digital, measurement signals representing physical or chemical, measured variables of a process.

Usually, such field-devices are connected via a corresponding data transmission system (e.g. 4 mA to 20 mA current loop and/or digital data bus) with one another and/or with process control computers to which they send the measurement signals. Especially serving as data transmission systems are serial fieldbus systems, such as e.g. PROFIBUS-PA, FOUNDATION FIELDBUS, CAN-BUS, etc., as well as the corresponding transmission protocols.

The process control computers further process the transmitted measurement signals and visualize them, e.g. on monitors, as corresponding measurement results and/or convert them to control signals for process control elements such as e.g. magnetically operated valves, electric motors, etc.

Besides the primary function, namely that of producing measurement signals, modern field-devices can exhibit numerous further functionalities which support an efficient and safe conducting of the process to be observed. For this purpose, there are included, among others, such additional functions as the self monitoring of field-devices, the storing of measured values, the production of control signals for control elements, etc. Due to this high functionality of the field-devices, to an increasing extent, process controlling functions can be moved into the field-plane, and, consequently, the process control systems can be correspondingly decentralized, or organized in a decentralized manner. Furthermore, these additional functionalities can relate to e.g. also the startup of the field-device as well as its connecting to the data transmission system.

These above and, possibly, further functions of the field-devices are usually implemented by means of a field-device electronics including a microprocessor and software appropriately implemented therein. The software is downloaded, before or during startup of the field-device, into a permanent memory, e.g. a ROM, and are loaded into a volatile memory, e.g. a RAM, for the operation of the field-device.

In a nonvolatile, writable memory e.g. an EEPROM, additionally device data such as application data, compensation coefficients, calibration data, error reports, and other status parameters can be stored or periodically written, optionally under event control. Additionally, it is possible to write process data, for example, in the form of a drag indicator function, periodically or under event control.

In such case, it can be a problem that the number of write-accesses is limited for an EEPROM. For example, the 16 Kbit EEPROM of type 24C164 of the firm Atmel is specified as permitting one million write-accesses per cell. From this, it follows that, under normal operating conditions with a write-access about every five minutes, a lifetime of about ten years can be expected. Under special circumstances, the frequency of the write-accesses can be increased to such a degree that the lifetime of the EEPROM significantly decreases. This can, in the extreme case, lead to an unexpected device failure.

It is, therefore, an object of the present invention to provide an electronic device having a memory module overcoming the disadvantages of the devices of the state of the art.

The object is achieved according to the invention by the electronic device as defined in the independent patent claim 1.

The electronic device of the invention includes: A microprocessor; a nonvolatile, writable data-memory, which is writable for a predetermined, maximum write-access number MWN of write-accesses; and is characterized in that the device includes a counter which registers the write-accesses and the microprocessor generates an alarm signal as a function of the development of the number of write-accesses and, as required, the maximum write-access number MWN.

In a first embodiment of the invention, the microprocessor can generate an alarm signal when the difference between the maximum write-access number MWN and the current number of write-accesses exceeds a limit value. This limit value can be, for example, a fixedly predetermined number of write-accesses, a number of write-accesses predeterminable by the user, or a function of the difference between the maximum write-access number MWN and the current number of write-accesses, as well as the average number of write-accesses per unit time, respectively the average time interval between two write-accesses. In the second alternative, the average number of write-accesses per unit time, respectively the average time interval between two write-accesses, can be determined, for example, as a cumulative or sliding average-value.

In a second embodiment of the invention, the microprocessor can generate an alarm signal when the remaining lifetime of the nonvolatile, writable data-memory determined on the basis of the time development of the number of write-accesses and the maximum write-access number falls below a minimum time. The minimum time can be, for example, a predetermined value or a value predetermined by the user.

In a third embodiment of the invention, the microprocessor can generate an alarm signal when the average number of write-accesses per unit time exceeds a maximum rate, respectively the average time interval between two write-accesses falls below a minimum time. The maximum rate or the minimum time can, in each case, be either a fixedly predetermined value or a value predetermined by the user, or a function of the difference between the maximum write-access number MWN and the current number of write-accesses.

In the currently preferred embodiment of the invention, the nonvolatile, writable data-memory comprises an EEPROM.

To the extent that the number of write-accesses should be available, preferably, also after a temporary device failure, respectively failure of the energy supply, it is advisable that the current number of write-accesses be stored in the nonvolatile memory, for example the EEPROM.

Additionally, the access times of selected write-accesses can be stored in a RAM or in the EEPROM for ascertaining the access rates.

An efficient option is to integrate the counter of the write-accesses into the microprocessor.

In a further development of the invention, the electronic device comprises a field-device for measuring a chemical or physical, measured variable of a process or for control of an actuator such as a valve drive or a pump. Physical or chemical, measured variables of a process are, for example, volume, or mass, flow, fill level, pressure, temperature, humidity, analytic parameters such as pH value or other potentiometric variables, oxygen content, nitrate content, turbidity, gas concentration. This list of measured variables of a process is solely for the purpose of illustration and is in no case to be considered as limiting.

The field-device of the invention can be, for example, a field-device equipped for digital communication and having a communications interface, via which the microprocessor is connected with a fieldbus. A fieldbus can be, for example, a PROFIBUS-PA, a FOUNDATION FIELDBUS, or a CAN-BUS.

Exactly external accesses to the field-device via the fieldbus can effect a considerable increase in the write-accesses to the nonvolatile, writable memory; whereby the alarm function of the invention, in the sense of a predictive monitoring, becomes necessary.

In a further development, it is taken into consideration that an EEPROM includes a multiplicity of cells, for example two thousand. Lifetime is, in such case, especially, strongly limited when the write-accesses occur repeatedly to the same cells. Spreading the write-accesses among different cells effects, in contrast, wear and tear which is less strong. For the case in which, in a certain application, not always the same cells are accessed, but, instead, a plurality of different cells, respectively a plurality of different clusters of cells, it can be advantageous to measure the write-accesses or the individual cells or clusters with a plurality of counters, each of which is assigned to a different cell or cluster of cells and to bring about the generation of alarms in manner corresponding to the above explained criteria, when, for a cell or a cluster, a corresponding alarm condition is reached.

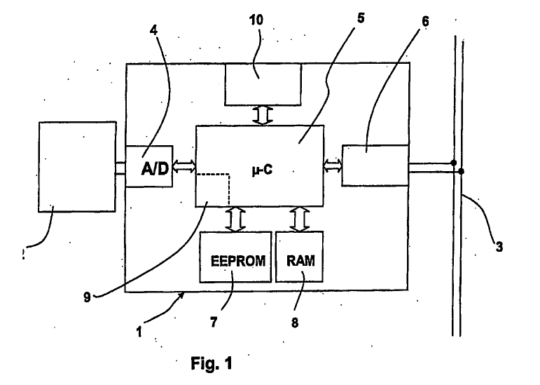

The invention will now be explained on the basis of an example of an embodiment illustrated in FIG. 1, which shows a block diagram of a field-device electronics of a field-device of the invention.

The field-device 1 of the invention is a measurement transmitter e.g. a pressure measuring transmitter, including a primary sensor unit 2 (with, if required, a preamplifier), the analog signal of which is fed via an A/D converter 4 to a microprocessor 5. The microprocessor 5 is additionally connected with a bus interface 6 via which it communicates with a fieldbus 3, for example a Foundation fieldbus.

The microprocessor is additionally functionally connected with an EEPROM 7, a RAM 8, and a ROM (not shown). For operating the measuring transmitter, the microprocessor program stored in the ROM is loaded into the RAM 8. Equally, compensation coefficients of the pressure sensor and other sensor, and status, data are read out of the EEPROM 7 and written into the RAM 8. As the processor carries out its functions, it works with the compensation parameters stored in the RAM 8, as well as the sensor and status data. At certain time intervals, updated average values of the measurement data are stored, via write-accesses, in the EEPROM 7. Additionally, for example, min and max data, as well as error events and status data can be updated, via write-accesses, in the EEPROM. Further write-accesses to the EEPROM 7 can be brought about via a display, and interaction, unit 10 or via the fieldbus 3, for example in a service mode, when application specific data or calibration data are to be updated. Especially in the case of write-accesses from external causes, an inordinately high rate of write-accesses can be experienced, which cause the EEPROM to age rapidly. In order, in such case, to be able to issue timely warnings in the sense of predictive maintenance, the measuring transmitter includes a counter 9, which registers the number of write-accesses and stores such, for example, in the EEPROM and/or in the RAM. The rate of write-accesses can be ascertained, for example, by storing the time of the Nth write-access and subtracting such from the time of the (N+M)th write-access, wherein M is to be selected sufficiently large that the determined rate is statistically meaningful. M can lie, for example, in the order of magnitude of some 10 s to 1000 s. When the rate is, for example, more than ten per minute, an alarm is generated and issued via the communication interface. Equally, an alarm is generated when, on the basis of the current write-access number and the average write-access rate, it is evident that the maximum write-access number MWN will be exceeded in less than a month.

1-17. (canceled)

18. An electronic device, comprising:
a microprocessor;
a nonvolatile, writable data-memory, which is writable for a predetermined maximum write-access number MWN of write-accesses; and
at least one counter which registers write-accesses, wherein:
said microprocessor produces an alarm signal as a function of the development of the number of write-accesses.

19. The electronic device as claimed in claim 18, wherein:
said microprocessor generates an alarm signal, when the difference between the maximum write-access number MWN and the current number of write-accesses falls below a limit value.

20. The electronic device as claimed in claim 19, wherein:
the limit value is a fixedly predetermined, or fixedly predeterminable, number of write-accesses.

21. The electronic device as claimed in claim 19, wherein:
the limit value is a function of the difference between the maximum write-access number MWN and the current number of write-accesses as well as the average number of write-accesses per unit time, respectively the average time interval between two write-accesses.

22. The electronic device as claimed in claim 21, wherein:
the average number of write-accesses per unit time, respectively the average time interval between two write-accesses, is determined as a cumulative, or sliding, average value.

23. The electronic device as claimed in claim 18, wherein:
said microprocessor generates an alarm signal, when the remaining lifetime of the nonvolatile, writable data-memory determined on the basis of the time development of the number of write-accesses and the maximum write-access number falls, below a minimum time.

24. The electronic device as claimed in claim 23, wherein:
the minimum time is a predetermined, or predeterminable, value.

25. The electronic device as claimed in claim 18, wherein:
said microprocessor generates an alarm signal, when the average number of write-accesses per unit time exceeds a limit value, respectively the average time interval between two write-accesses falls below a limit value.

26. The electronic device as claimed in claim 25, wherein:
the limit value is a fixedly predetermined, or predeterminable, value.

27. The electronic device as claimed in claim 25, wherein:
the limit value is a function of the difference between the maximum write-access number MWN and the current number of write-accesses.

28. The electronic device as claimed in claim 27, wherein:
said nonvolatile, writable data-memory comprises an EEPROM.

29. The electronic device as claimed in claim 28, wherein:
the current number of write-accesses and/or times of elected write-accesses are/is stored in a RAM or in said EEPROM.

30. The electronic device as claimed in claim 18, wherein:
said at least one counter is integrated into the microprocessor.

31. The electronic device as claimed in claim 18, wherein:
the electronic device is a field-device for one of:
measuring a chemical or physical, process measured variable, and for controlling an actuator.

32. The electronic field-device as claimed in claim 31, wherein:
said filed device further comprising:
a communication interface, via which said microprocessor is connected with a fieldbus.

33. The electronic device as claimed in claim 32, wherein:
a majority of write-accesses to the EEPROM are caused by signals transmitted via the fieldbus.

34. The electronic device as claimed in claim 18, wherein:
said data-memory includes at least two cells or clusters of cells with a corresponding number of counters associated in each case with the cells or clusters and which register the respective write-accesses; and
said microprocessor generates an alarm signal as a function of the development of the number of write-accesses to the individual cells or clusters.
